(19) United States
(12) Patent Application Publication
(10) Pub. No.: US 2025/0292499 A1
(43) Pub. Date: Sep. 18, 2025

(54) Method for Creating and Controlling Modular Performance Content

(71) Applicant: WaveXR, Inc., Los Angeles, CA (US)

(72) Inventors: Sean Dunn, Austin, TX (US); Adam Siegel, Long Beach, CA (US)

(73) Assignee: WaveXR, Inc., Los Angeles, CA (US)

(21) Appl. No.: 19/082,799

(22) Filed: Mar. 18, 2025

Related U.S. Application Data
(60) Provisional application No. 63/566,469, filed on Mar. 18, 2024.

(51) Int. Cl. G06T 17/00

(52) U.S. Cl. CPC G06T 17/00

(57) ABSTRACT

A method for creating content, the method comprising: inputting one or more streams of data; wherein the streams of data comprises music data, synchronization data, object data, and scene data; defining objects; wherein the properties of objects of the streams of data are defined in a functional nature; creating scenes; wherein the scenes are defined by a set of objects; wherein the scenes have a set of properties defined by an expression; transitioning; wherein each set of objects is transitioned from a first scene to a second scene; and interpolating; wherein objects of a scene are compatible but have different expressions; wherein the objects are transitioned over a duration of time.

### CROSS REFERENCE PARAGRAPH

This U.S. Non-Provisional patent application claims the benefit of and priority to U.S. Provisional Patent Application No. 63/566,469, filed on Mar. 18, 2024, by inventors Sean Dunn and Adam Siegel, the contents of which are expressly incorporated herein by this reference.

### FIELD OF USE

The present disclosure relates, in general, to a method for creating and controlling modular performance content. More specifically, the present disclosure relates to a method of creating an audio visual performance driven by live performances that uses previously saved content.

### BACKGROUND

Generally, a live performance viewed in a 3D graphics engine has objects having properties and behaviors. Transitioning between object behaviors is traditionally done in a pre-animated way, using timelines, or ad hoc imperative programming, where a state is detected, and imperative code schedules all changes in a specific way.

Using traditional game engine concepts, the data and logic comprising the performance can easily become a tangled monolith of behaviors, objects, events, and temporary state holders. Traditional game engine concepts make content reuse difficult.

Animated state and dependent logic cannot easily be separated by a logical boundary of “scenes” and be reorganized in time or stored in a library for later inclusion. This would require animated data and complex logic to be refactored by logical scene boundaries, and special logic or content changes would be required to blend properties between scene transitions.

Therefore, what is needed is a method of transitioning between scenes that allows content to be reused to improve transitions smoothly and efficiently, in a deterministic manner without side effects.

### SUMMARY

To minimize the limitations in the prior art, and to minimize other limitations that will become apparent upon reading and understanding the present specification, the present disclosure discloses a new and useful method of creating and controlling modular performance content.

The following presents a simplified overview of the example embodiments in order to provide a basic understanding of some embodiments of the example embodiments. This overview is not an extensive overview of the example embodiments. It is intended to neither identify key or critical elements of the example embodiments nor delineate the scope of the appended claims. Its sole purpose is to present some concepts of the example embodiments in a simplified form as a prelude to the more detailed description that is presented herein below. It is to be understood that both the following general description and the following detailed description are exemplary and explanatory only and are not restrictive.

The solution to transitioning between scenes is solved by defining content behavior in a functional only manner driven by input properties.

The method of the present disclosure may include sending multiple streams of music and data, including synchronizing the data such that a person singing has the music synchronized with their mouth movement. The method may also remotely control synchronized data such as lighting data, movements, or actions that trigger other actions or events in the experience.

The method forces the content creator to define behavior in a primarily functional way (driven only by input properties, with minimal retained state frame per frame), and to describe the current state of the performance declaratively, such that performance states can be transitioned between easily by simply blending their inputs.

The creator of the performance authors it as a prepared or live concatenation of short “scenes”. Each scene contains a set of objects and represents a stylistic choice.

Objects within each scene can exist in multiple neighboring scenes for continuity.

If an object ceases to exist in a new scene, or begins to exist in a new scene, that object must have its own strategy for handling those cases. By default, this would be simply disappearing/appearing.

The transition from one scene to another is blended at the object property level, ensuring smoothness. Object properties are driven by a state that can be animated by recorded or procedural data. The data that drives object properties must either be purely functional in nature, or it must come from an authoritative single source. All states are represented by live references to this source every tick of the performance simulation and cannot be owned by the objects.

The disclosure teaches a method of creating content in a modular process, with dependencies defined by a clear data flow.

The action of transitioning state is embodied as an automatic behavior based on structured declarative expressions, and not an unstructured collection of custom imperative logic.

Compared with traditional imperative control flow, it is simple to create a performance without bugs caused by state-based side effects, or unseen dependencies.

In one embodiment, the present disclosure may be used to transmit a live 3D animated performance between two clients on a network.

Sending changes to the imperative application state over the network as it happens may result in an out-of-order evaluation on the local computer, side effects, and the inability to roll back changes if things get into a bad state or use. A high-level brute force solution to send all data that describes the system as a time series, and have the local machine set that data every frame may require impractical amounts of network bandwidth.

One embodiment may be a method for creating content, the method comprising: inputting one or more streams of data; wherein the one or more streams of data comprises music data, synchronization data, object data, and scene data; defining one or more objects; wherein the properties of objects of the one or more streams of data are defined in a functional nature; creating one or more scenes; wherein the one or more scenes are defined by a set of objects; wherein the one or more scenes have a set of properties defined by an expression; transitioning; wherein each set of objects is transitioned from a first scene to a second scene; and interpolating; wherein one or more objects of a scene are compatible but have different expressions; wherein the one or more objects are transitioned over a duration of time.

Another embodiment may be a method for creating modular performance content, the method comprising: providing a 3D graphics engine; generating one or more digital objects by the 3D graphics engine based on one or more object properties; displaying the one or more digital objects in one or more sequential scenes; and applying a condition to the one or more digital objects between sequential scenes. The one or more sequential scenes may comprise a prior scene and a subsequent scene defined by a scene transition from the prior scene to the subsequent scene. The condition may comprise a continuing status, an appearing status, and a disappearing status. The continuing status may apply to the one or more digital objects when the one or more digital objects exists in the prior scene and the subsequent scene. The continuing status may result in the one or more digital objects continuing to be displayed through the scene transition. The appearing status may apply to the one or more digital objects when the one or more digital objects does not exist in the prior scene and does exist in the subsequent scene. The appearing status may result in the one or more digital objects appearing during the scene transition. The disappearing status may apply to the one or more digital objects when the one or more digital objects exists in the prior scene and does not exist in the subsequent scene. The disappearing status may result in the one or more digital objects disappearing during the scene transition. The disappearing status may result in the one or more digital objects shrinking down to nothing during the scene transition. The object properties may be defined by an expression. The object properties may be functional. The object properties may be derived from an authoritative single source. The scene transition may be performed by a transition controller.

In some embodiments, the present disclosure offers a solution that is to pre-configure large scale behavior such that it can be applied or removed in blocks and drive small scale behavior as procedurally as possible using much smaller network streams of time series data. This concept manifests itself through a system that allows large scale states to be describes as “scenes”, where each scenes' internal state is driven by time series inputs. In one embodiment, several variations of stages and lighting may be described, and then sparse time series data may be sent to control the performer's animation, and light colors over time. Every scene may be reverted so that by removing them all, it may be possible to achieve the original visual state without side effects.

These, as well as other components, steps, features, objects, benefits, and advantages, will now become clear from a review of the following detailed description of illustrative embodiments, the accompanying drawings, and the claims.

### BRIEF DESCRIPTION OF THE DRAWINGS

The drawings are of illustrative embodiments. They do not illustrate all embodiments. Other embodiments may be used in addition or instead. Details which may be apparent or unnecessary may be omitted to save space or for more effective illustration. Some embodiments may be practiced with additional components or steps and/or without all of the components or steps which are illustrated. When the same numeral appears in different drawings, it refers to the same or like components or steps.

FIG. 1 is a flow block diagram showing a scene transition of a visual audio performance driven by live performance.

FIG. 2 is a flowchart of one embodiment of a method for creating modular performance content.

### DETAILED DESCRIPTION OF THE ILLUSTRATIVE EMBODIMENTS

In the following detailed description of various embodiments of the present disclosure, numerous specific details are set forth in order to provide a thorough understanding of various aspects of one or more embodiments of the present disclosure. However, one or more embodiments of the present disclosure may be practiced without some or all of these specific details. In other instances, well-known methods, procedures, and/or components have not been described in detail so as not to unnecessarily obscure aspects of embodiments of the present disclosure.

While multiple embodiments are disclosed, still other embodiments of the devices, systems, and methods of the present disclosure will become apparent to those skilled in the art from the following detailed description, which shows and describes illustrative embodiments of the devices, systems, and methods of the present disclosure. As will be realized, the devices, systems, and methods of the present disclosure are capable of modifications in various obvious aspects, all without departing from the spirit and scope of the present disclosure. Accordingly, the screenshot figures, and the detailed descriptions thereof, are to be regarded as illustrative in nature and not restrictive. Also, the reference or non-reference to a particular embodiment of the devices, systems, and methods of the present disclosure shall not be interpreted to limit the scope of the present disclosure.

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers, or steps. “Exemplary” means “an example of” and is not intended to convey an indication of a preferred or ideal embodiment. “Such as” is not used in a restrictive sense, but for explanatory purposes.

Disclosed are components that may be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all embodiments of this application including, but not limited to, steps in disclosed methods. Thus, if there are a variety of additional steps that may be performed it is understood that each of these additional steps may be performed with any specific embodiment or combination of embodiments of the disclosed methods.

The present methods and systems may be understood more readily by reference to the following detailed description of preferred embodiments and the examples included therein and to the Figures and their previous and following description.

In the following description, certain terminology is used to describe certain features of one or more embodiments. For purposes of the specification, unless otherwise specified, the term “substantially” refers to the complete or nearly complete extent or degree of an action, characteristic, property, state, structure, item, or result. For example, in one embodiment, an object that is “substantially” located within a housing would mean that the object is either completely within a housing or nearly completely within a housing. The exact allowable degree of deviation from absolute completeness may in some cases depend on the specific context. However, generally speaking, the nearness of completion will be so as to have the same overall result as if absolute and total completion were obtained. The use of “substantially” is also equally applicable when used in a negative connotation to refer to the complete or near complete lack of an action, characteristic, property, state, structure, item, or result.

As used herein, the terms “approximately” and “about” generally refer to a deviance of within 5% of the indicated number or range of numbers. In one embodiment, the term “approximately” and “about”, may refer to a deviance of between 0.001-40% from the indicated number or range of numbers.

Various embodiments are now described with reference to the drawings. In the following description, for purposes of explanation, numerous specific details are set forth in order to provide a thorough understanding of one or more embodiments. It may be evident, however, that the various embodiments may be practiced without these specific details. In other instances, well-known structures and devices are shown in block diagram form to facilitate describing these embodiments.

Furthermore, the one or more versions may be implemented as a method, apparatus, or article of manufacture using standard programming and/or engineering techniques to produce entirely hardware embodiments, an entirely software embodiment, or an embodiment combining software and hardware embodiments. Furthermore, the systems and methods may take the form of non-transitory computer readable media. More particularly, the present methods and systems may take the form of web-implemented computer software or a computer program product. Any suitable computer-readable storage medium may be utilized including, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick).

Those skilled in the art will recognize that many modifications may be made to this configuration without departing from the scope of the disclosed embodiments.

Embodiments of the systems and methods are described below with reference to schematic diagrams, block diagrams, and flowchart illustrations of methods, systems, apparatuses, and computer program products. It will be understood that each block of the block diagrams, schematic diagrams, and flowchart illustrations, and combinations of blocks in the block diagrams, schematic diagrams, and flowchart illustrations, respectively, may be implemented by computer program instructions. These computer program instructions may be loaded onto a general-purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, may be implemented by special purpose hardware-based computer systems that perform the specified functions or steps, or combinations of special purpose hardware and computer instructions.

In the following description, certain terminology is used to describe certain features of the various embodiments of the device, method, and/or system. For example, as used herein, the terms “computer” and “computer system” generally refer to any device that processes information with an integrated circuit chip and/or central processing unit (CPU).

As used herein, the terms “software” and “application” refer to any set of machine-readable instructions on a machine, web interface, and/or computer system” that directs a computer's processor to perform specific steps, processes, or operations disclosed herein.

As used herein, the term “computer-readable medium” refers to any storage medium adapted to store data and/or instructions that are executable by a processor of a computer system. The computer-readable storage medium may be a computer-readable non-transitory storage medium and/or any non-transitory data storage circuitry (e.g., buggers, cache, and queues) within transceivers of transitory signals. The computer-readable storage medium may also be any tangible computer readable medium. In various embodiments, a computer readable storage medium may also be able to store data, which is able to be accessed by the processor of the computer system.

The visual content of a performance is defined by a set of objects in a declarative manner. The behavior of the content is defined by input properties on each object. The input properties may be driven by static values or evaluated expressions that output dynamic values. Property expressions may be driven by procedural functions and/or combined with live data received from a performance.

A specific collection of objects and their property settings is called a “scene”. Multiple scenes may share one or more of the same objects between them. When an object is the same between multiple scenes (by name and type), but only differs by its parameters, it is referred to as a “compatible” object. For example, a spotlight named “Light0” in one scene may be narrow and green, but another light named “Light0” is wide and blue in the next scene.

Changing between two scenes is called a “transition”. During a transition between two scenes, for each compatible object that is represented in both scenes, the input configured property expressions are interpolated, over a defined duration. For example, a spotlight named “Light0” in one scene may be narrow and green, but another light named “Light0” is wide and blue in the next scene, the light transitions from blue to green, and the spotlight angle changes from wide to narrow.

If an object is not represented in the target scene of a transition, it is commanded to disappear over this duration. How an object disappears is dependent upon its implementation. If an object only exists in the target scene of a transition, it is commanded to appear in a similar implementation and dependent way. For example, a tree may shrink down to nothing to disappear, or a sky object may fade in to appear.

An alternative method of completing the transitions between scenes may include defining each scene as a named “state” in a classic state machine. Each object property would then require a table that maps a specific scene state to a specific expression for that state. For each global state change, each property must transition between the appropriate start and end expressions to interpolate between the old and new states. As a new state is introduced, every property that is affected by the new state may require an update on a per-property basis before it can be visualized. Data management for a complex show may require complex UIs to allow aggregation and editing of object properties across states, for multiple states and objects.

An alternative method of completing the transitions between scenes may include placing all objects in the show on a timeline and mapping specific scene states to keyframes in the timeline.

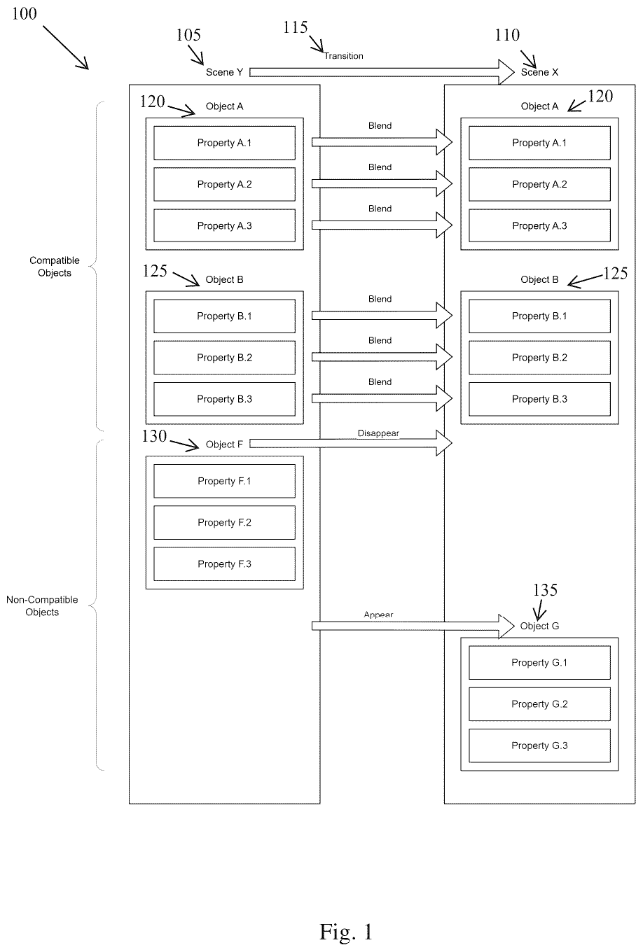

FIG. 1 is a flow block diagram showing a scene transition of a visual audio performance driven by live performance.

As shown in FIG. 1, scene transition 100 may comprise Scene Y 105, Scene X 110, and transition 115. Object A 120, Object B 125, and Object F 130 may be present in Scene Y 105. Object A 120, Object B 125, and Object G 135 may be present in Scene X 110.

Object A 120 and Object B 125 may be considered compatible objects due to their appearance in both Scene Y 105 and Scene X 110, and as a result Object A 120 and Object B 125 may be blended during the transition 115 in appearing in Scene Y 105 and then Scene X 110.

Object F 130 and Object G 135 may be considered non-compatible objects because they do not appear in both Scene Y 105 and Scene X 110.

During the transition 115, Object F 130 may disappear.

During the transition 115, Object G 135 may appear.

Each of Object A 120, Object B 125, Object F 130, and Object G 135 may each comprise one or more properties.

In some embodiments more or fewer objects may be present.

Content creation may include: 1) creating a root scene with a transition controller; 2) creating transition scenes for each individual transition state; 3) adding scene objects to each transition scene; 4) authoring expressions on appropriate object properties; and 5) register transition scenes with the transition controller.

Content performance may include: 1) selecting a transition scene as current through the transition controller user interface; 2) transitioning the scenes: by determining which objects are shared between the origin and target scene, which exist only in the origin scene, and which exist only in the target scene. Compatible objects may be interpolated between the origin and target expressions for each property. Origin-only objects may have the object disappear over a duration time using its own implementation of disappearing. Target-only objects, have the object appear over the duration time using its own implementation of appearing.

The method may allow control of audio-visual mediums having scene object embedded properties driven by interpolated expressions. Some examples include video, audio, user interfaces, and robotics.

The method may be used to synchronize performance state between two types of applications (a broadcaster client and receiver client) on a computer network. In the event that a scene object is not driven solely by the input state from a broadcaster client the output of a transition may not be deterministic. For example, if the scene object retains its own state or sense of time.

The disclosed method describes a set of operations and structure for creating a performance out of a set of content objects, each with property expressions that are possibly driven by live performance. The method enforces a declarative and functional data flow paradigm for transitioning between complex performance states. The method included defining objections, creating scenes, and transitioning objects between scenes. A transition controller may complete the transition.

An object may be a manifestation of visual or audio behavior in a performance. Each object in each scene has a set of properties, each defined by an expression. The expression may be self-contained or depend upon live inputs.

A Scene is defined by a set of objects. The metadata from a set of scenes is used to drive a UI that can orchestrate which scene should be currently shown, and when. This orchestration may be prepared or live.

A transition controller transitions from one scene to another. When a scene is selected, the transition controller transitions from one scene to another. Each scene is a set of objects, but some objects may exist in multiple scenes, bound by the fact that they have the same name and object type. These are called compatible objects.

Compatible objects may have different expressions that drive their properties. When two of the same compatible objects are blended between, the expressions for each property are interpolated between the origin and target scenes over a duration of time.

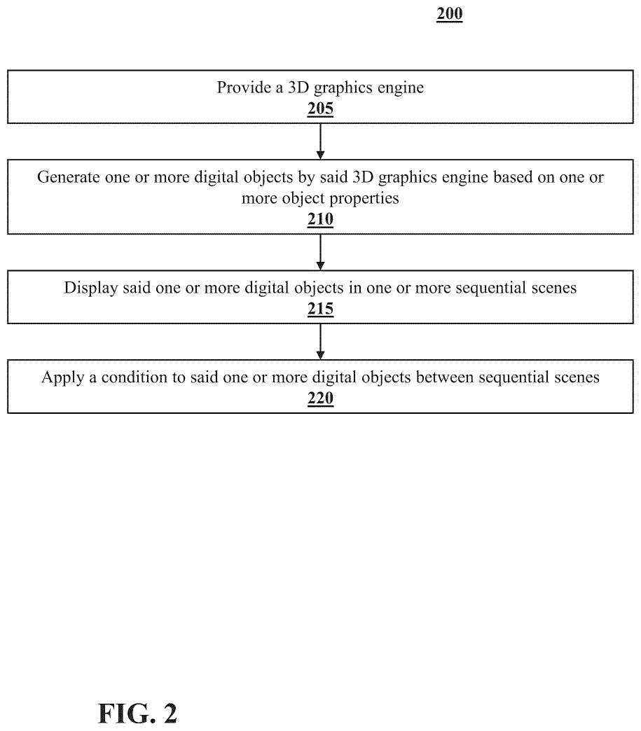

FIG. 2 is a flowchart of one embodiment of a method for creating modular performance content. In some implementations, one or more process blocks of FIG. 2 may be performed by a device.

As shown in FIG. 2, the method 200 may include providing a 3D graphics engine 205, generating one or more digital objects by said 3D graphics engine based on one or more object properties 210, displaying said one or more digital objects in one or more sequential scenes 215, and applying a condition to said one or more digital objects between sequential scenes 220.

In some embodiments, one or more sequential scenes may include a prior scene and a subsequent scene defined by a scene transition from the prior scene to the subsequent scene. The condition may include a continuing status, an appearing status, and a disappearing status.

In some embodiments, the continuing status applies to the one or more digital objects when the one or more digital objects exists in the prior scene and the subsequent scene. A continuing status results in the one or more digital objects continuing to be displayed through the scene transition.

In some embodiments, the appearing status applies to the one or more digital objects when the one or more digital objects does not exist in the prior scene and does exist in the subsequent scene. In some embodiments, the appearing status results in the one or more digital objects appearing during the scene transition.

In some embodiments, the disappearing status applies to the one or more digital objects when the one or more digital objects exists in the prior scene and does not exist in the subsequent scene. In some embodiments, the disappearing status results in the one or more digital objects disappearing during the scene transition. In some embodiments, the disappearing status results in the one or more digital objects shrinking down to nothing during the scene transition.

In some embodiments, the object properties are defined by an expression. In some embodiments, the object properties are functional. This functional characterization may be driven by input properties, with minimal retained state frame per frame. This may also result in the current state of performance being described declaratively, such that performance states may be transitioned by blending their inputs. In some embodiments, the object properties are derived from an authoritative single source. Objects in one scene may exist in multiple neighboring scenes. In some embodiments, the object properties may allow for the objects to appear or disappear with various sorts of animations.

In some embodiments, the scene transition is performed by a transition controller. In a preferred embodiment, transitions from one scene to another are blended at the object property level, which may increase smoothness.

Although FIG. 2 shows example blocks of method 200, in some implementations, method 200 may include additional blocks, fewer blocks, different blocks, or differently arranged blocks than those depicted in FIG. 2. Additionally, or alternatively, two or more of the blocks of method 200 may be performed in parallel.

Unless otherwise stated, all measurements, values, ratings, positions, magnitudes, sizes, locations, and other specifications that are set forth in this specification, including in the claims that follow, are approximate, not exact. They are intended to have a reasonable range that is consistent with the functions to which they relate and with what is customary in the art to which they pertain.

Some portions of the preceding detailed descriptions have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it should be appreciated that throughout the present disclosure, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system's memories or registers or other such information storage, transmission or display devices.

The processes or methods depicted in the figures may be performed by processing logic that comprises hardware (e.g., circuitry, dedicated logic, etc.), firmware, software (e.g., embodied on a non-transitory computer readable medium), or a combination thereof. Although the processes or methods are described above in terms of some sequential operations, it should be appreciated that some of the operations described may be performed in a different order. Moreover, some operations may be performed in parallel rather than sequentially.

In addition, the various illustrative logical blocks, modules, and circuits described in connection with certain embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, system-on-a-chip, or state machine. A processor may also be implemented as a combination of computing devices, e.g., a combination of a DSP and a microprocessor, a plurality of microprocessors, one or more microprocessors in conjunction with a DSP core, or any other such configuration.

Operational embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, a DVD disk, or any other form of storage medium known in the art. An exemplary storage medium is coupled to the processor such the processor may read information from, and write information to, the storage medium. In the alternative, the storage medium may be integral to the processor. The processor and the storage medium may reside in an ASIC or may reside as discrete components in another device.

Furthermore, the one or more versions may be implemented as a method, apparatus, or article of manufacture using standard programming and/or engineering techniques to produce software, firmware, hardware, or any combination thereof to control a computer to implement the disclosed embodiments. Non-transitory computer readable media may include but are not limited to magnetic storage devices (e.g., hard disk, floppy disk, magnetic strips), optical disks (e.g., compact disk (CD), digital versatile disk (DVD)), smart cards, and flash memory devices (e.g., card, stick). Those skilled in the art will recognize that many modifications may be made to this configuration without departing from the scope of the disclosed embodiments.

The foregoing description of the preferred embodiment has been presented for the purposes of illustration and description. While multiple embodiments are disclosed, still other embodiments will become apparent to those skilled in the art from the above detailed description. These embodiments are capable of modifications in various obvious aspects, all without departing from the spirit and scope of protection. Accordingly, the detailed description is to be regarded as illustrative in nature and not restrictive. Also, although not explicitly recited, one or more embodiments may be practiced in combination or conjunction with one another. Furthermore, the reference or non-reference to a particular embodiment shall not be interpreted to limit the scope of protection. It is intended that the scope of protection is not limited by this detailed description, but by the claims and the equivalents to the claims that are appended hereto.

Except as stated immediately above, nothing that has been stated or illustrated is intended or should be interpreted to cause a dedication of any component, step, feature, object, benefit, advantage, or equivalent, to the public, regardless of whether it is or is not recited in the claims.

What is claimed is:

1. A method for creating content, the method comprising:
inputting one or more streams of data;
wherein said one or more streams of data comprises music data, synchronization data, object data, and scene data;
defining one or more objects of said one or more streams of data;
wherein a plurality of properties of said one or more objects of said one or more streams of data are defined in a functional nature;
creating at least one scene;
wherein said scene is defined by a set of objects;
wherein said scene has a set of properties defined by an expression;
transitioning said one or more sets of objects;
wherein said set of objects is transitioned from said scene to a second scene; and
interpolating said set of objects;
wherein said set of objects of said scene and of said second scene are compatible but have different expressions;
wherein said one or more objects are transitioned over a duration of time.

2. A method for creating modular performance content, the method comprising:
providing a 3D graphics engine;
generating one or more digital objects by said 3D graphics engine based on one or more object properties;
displaying said one or more digital objects in one or more sequential scenes; and
applying a condition to said one or more digital objects between sequential scenes.

3. The method of claim 2, wherein said one or more sequential scenes comprise a prior scene and a subsequent scene defined by a scene transition from said prior scene to said subsequent scene.

4. The method of claim 3, wherein said condition comprises one or more of a continuing status, an appearing status, and a disappearing status.

5. The method of claim 4, wherein said continuing status applies to said one or more digital objects when said one or more digital objects exist in both said prior scene and said subsequent scene.

6. The method of claim 5, wherein said continuing status results in said one or more digital objects continuing to be displayed through said scene transition.

7. The method of claim 4, wherein said appearing status applies to said one or more digital objects when said one or more digital objects do not exist in said prior scene but do exist in said subsequent scene.

8. The method of claim 7, wherein said appearing status results in said one or more digital objects appearing during said scene transition.

9. The method of claim 4, wherein said disappearing status applies to said one or more digital objects when said one or more digital objects exist in said prior scene but do not exist in said subsequent scene.

10. The method of claim 9, wherein said disappearing status results in said one or more digital objects disappearing during said scene transition.

11. The method of claim 9, wherein said disappearing status results in said one or more digital objects shrinking down to nothing during said scene transition.

12. The method of claim 3, wherein said one or more object properties are defined by an expression.

13. The method of claim 3, wherein said one or more object properties are functional.

14. The method of claim 3, wherein said one or more object properties are derived from an authoritative single source.

15. The method of claim 3, wherein said scene transition is performed by a transition controller.
